(19) United States
(12) Patent Application Publication
(10) Pub. No.: US 2016/0350810 A1
(43) Pub. Date: Dec. 1, 2016

(54) In Ad Messaging

(71) Applicant: Radialpoint Safecare Inc., Montreal (CA)

(72) Inventor: Alexis Smirnov, Brossard (CA)

(21) Appl. No.: 14/807,537

(22) Filed: Jul. 23, 2015

Related U.S. Application Data
(60) Provisional application No. 62/168,327, filed on May 29, 2015.

(51) Int. Cl. G06Q 30/02; H04W 4/00; H04M 1/725

(52) U.S. Cl. CPC G06Q 30/0267; H04M 1/72552; H04W 4/003; G06Q 30/0255

(57) ABSTRACT

Methods, devices, systems, and computer program products for in-ad messaging are provided. For example, a mobile device displays an advertisement with a built-in messaging area to a user of a mobile app. While the user is in a context of the mobile app, the mobile device receives user input via the messaging area of the advertisement, and in response, sends a first text-based message to an advertising server associated with the advertisement without affecting the context of the mobile app. In response to sending the text-based message, the mobile device receives a response from the advertising server over a push-notification channel of the mobile app and displays a second text-based message to the user via the messaging area.

### TECHNICAL FIELD

The present disclosure generally relates to enabling mobile devices to provide mobile messaging areas within online advertisements, and more specifically relates to enabling an advertisement displayed within a mobile app presented by the mobile device to make use of a push notification channel of the mobile app.

### BACKGROUND

Many mobile apps display advertisements to users, for example, as a way to subsidize the cost of developing and/or maintaining the mobile app. These advertisements are often nothing more than a picture that may be tapped should the user desire more information about what is advertised. Typically, tapping the ad causes the user to be converted, i.e., to be taken away from their current mobile app context and brought into a new advertising context where the user may get more detail about the advertised product or service. Users are often hesitant to tap such ads because such conversions may be disruptive to their current use of the mobile device.

### SUMMARY

According to one or more embodiments, a mobile device displays an advertisement with a built-in messaging area to a user of a mobile app. While the user is in a context of the mobile app, the mobile device receives user input via the messaging area of the advertisement and, in response, sends a first text-based message to an advertising server associated with the advertisement without affecting the context of the mobile app. In response to sending the text-based message, the mobile device receives a response from the advertising server over a push-notification channel of the mobile app and displays a second text-based message to the user via the messaging area.

One or more embodiments of the present disclosure include methods, devices, systems, and computer program products of messaging within an advertisement. These embodiments include, for example, a method of messaging within an advertisement that is implemented by a mobile device. The method may comprise displaying, within a mobile app, an advertisement comprising a messaging area; receiving a push notification addressed to the mobile app from an advertising server associated with the advertisement; and displaying text, comprised within the push notification, within a messaging area of the advertisement.

In some embodiments, the method comprises receiving the push notification in response to transmitting user input received via the messaging area of the advertisement to the advertising server. In an embodiment, the user input is received via the messaging area without causing a change in context to the mobile app. In an embodiment, the method further comprises closing the mobile app subsequent to transmitting the user input, and in response to receiving the push notification, launching the mobile app in order to redisplay the user input within the messaging area of the advertisement within the mobile app. In an embodiment, the method further comprises removing the mobile app from display subsequent to transmitting the user input, and in response to receiving the push notification, redisplaying the user input within the messaging area of the advertisement within the mobile app. In an embodiment, the method further comprises replacing the advertisement with a different advertisement after transmitting the user input, and redisplaying the advertisement in response to receiving the push notification.

In some embodiments, the method further comprises registering the mobile app with a push server to obtain push notification credentials; providing the push notification credentials to an advertising module of the mobile app; and transmitting the push notification credentials, via the advertising module, to the advertising server.

Other embodiments may include a mobile device for in-ad messaging. The mobile device may, for example, comprise interface circuitry, communication circuitry, and processing circuitry communicatively coupled to the interface circuitry and communication circuitry. The interface circuitry may be configured to receive input from, and produce output to, a user. The communication circuitry may be configured to send and receive radio signals over a wireless network. The processing circuitry may be configured to display, within a mobile app, an advertisement comprising a messaging area via the interface circuitry; receive a push notification addressed to the mobile app from an advertising server associated with the advertisement via the communication circuitry; and display text, comprised within the push notification, within the messaging area via the interface circuitry. The mobile device may be otherwise configured to carry out any of the methods described herein.

Other embodiments may include a non-transitory computer readable medium for controlling a programmable mobile device in a communication network, the computer program product comprising software instructions that, when run on the programmable mobile device, cause the programmable mobile device to carry out any of the methods described herein.

### BRIEF DESCRIPTION OF THE DRAWINGS

FIG. 1 is a block diagram illustrating an exemplary system, according to one or more embodiments.

FIG. 2 is a block diagram illustrating an exemplary mobile app comprising an advertisement, according to one or more embodiments.

FIG. 3 is a signaling diagram illustrating the exchange of signals between entities, according to one or more embodiments.

FIG. 4 is a flow diagram illustrating an exemplary method, according to one or more embodiments.

FIG. 5 is a flow diagram illustrating a more detailed exemplary method, according to one or more embodiments.

FIG. 6 is a block diagram illustrating exemplary hardware, according to one or more embodiments.

### DETAILED DESCRIPTION

For simplicity and illustrative purposes, the present disclosure is described by referring mainly to an exemplary embodiment thereof. In the following description, numerous specific details are set forth in order to provide a thorough understanding of the present invention. However, it will be readily apparent to one of ordinary skill in the art that the present invention may be practiced without limitation to these specific details. In this description, well known methods and structures have not been described in detail so as not to unnecessarily obscure the present invention.

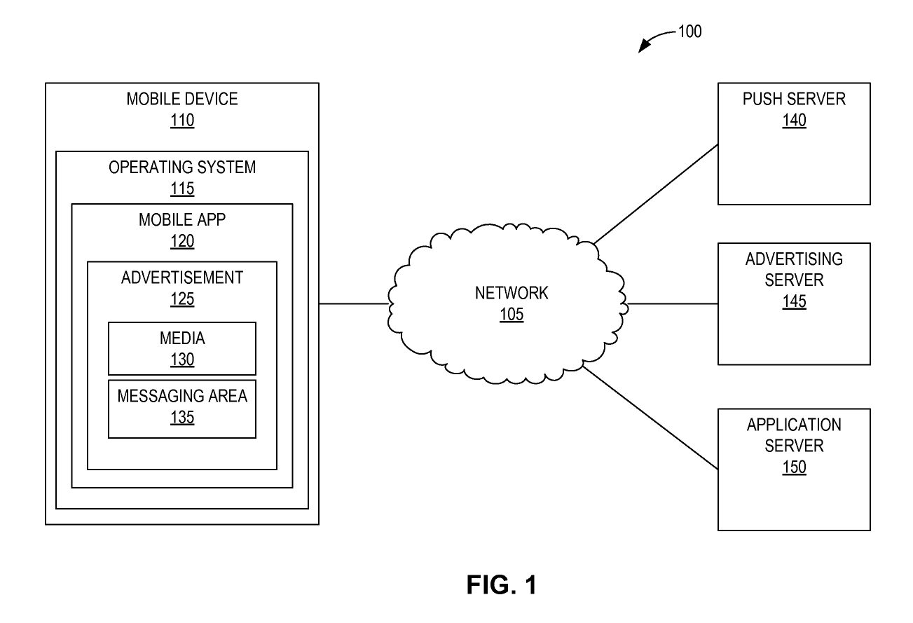

FIG. 1 illustrates an exemplary system 100, according to one or more embodiments. The system 100 comprises a mobile device 110, a push server 140, an advertising server 145, and an application server 150, each of which is connected to a network 105. The network 105 may be any network 105 capable of carrying messages between the mobile device 110, push server 140, advertising server 145, and application server 150, including (but not limited to) the Internet, one or more local area networks, one or more wireless networks, one or more cellular networks, one or more Internet Protocol-based networks, and/or one or more circuit switched networks.

The mobile device 110 may be any mobile device 110 that is capable of displaying information on a display, communicating over a wireless network, and accepting user input from a local user. For example, the mobile device 110 may be a smartphone, a wearable computer, or a tablet. The mobile device 110 may execute an operating system 115. The operating system 115 may be any operating system 115 capable of executing mobile apps, e.g., ANDROID, 10S, or WINDOWS. A particular mobile app 120 running within the operating system 115 may comprise a particular context in which the user may interact with the mobile app 120. For example, if the mobile app 120 is a document editor, the context may include a workspace for editing a document. In another example, if the mobile app 120 is a web browser, the context may include a user interface for viewing and navigating a webpage. In such examples, closing/changing the document being edited, or the webpage being viewed, respectively, may change the context of the mobile app 120, e.g., by altering the primary purpose of the workspace and/or user interface. Myriad contexts are possible, depending on the mobile app 120 and actions of the user. Although fully describing mobile app 120 contexts would be far too numerous to fully enumerate here, such contexts will be readily understood to those of ordinary skill in the art.

The mobile app 120 may display an advertisement 125 within the context of the mobile app 120. For example, the mobile app 120 may reserve a portion of the mobile device's 110 physical display for presenting the advertisement 125, or may dynamically shrink a workspace of the mobile app 120 in order to accommodate the advertisement 125 as needed. Thus, the advertisement 125 may be displayed in a manner that does not interfere with the workspace of the mobile app 120 (or interferes with the workspace within the context of the mobile app 120 to only a slight degree). According to one or more embodiments, an advertising code module may be responsible for acquiring and displaying the advertisement 125. The advertising code module may also be responsible for swapping the advertisement 125 out periodically, locally storing common ad content, and/or responding to user interaction with particular advertisements. Such an advertising code module may be included within and/or linked to the mobile app 120, e.g., statically or dynamically.

The advertisement 125 may comprise media 130 and a messaging area 135. The media 130 may comprise artwork, information, pictures, text, video, and/or other multimedia pertaining to a particular product and/or service being advertised. The messaging area 135, as will be explained in further detail below, may enable the user to engage in messaging with an advertiser that corresponds to the advertisement 125 via the messaging area 135.

The application server 150 may execute a service remotely from the mobile device 110 in support of the mobile app 120. For example, the mobile app 120 may be a weather app, and the application server 150 may execute a weather service that determines the weather for multiple geographies and provides the mobile device 110 with information via the Internet about the weather in the geography where the mobile device 110 is presently located. For another example, the mobile app 120 may be a news app, and the application server 150 may execute a news aggregation service that provides the mobile device 110 with news articles via the Internet that relate to the interests and locality of a user of the mobile device 110. Thus, the mobile app 120 and application server 150 may communicate with each other via the Internet and may cooperate to enhance the functionality of the mobile app 120 for a user of the mobile device 110.

The information sent from the application server 150 to the mobile device 110 may be sent via one or more push notifications. These push notifications may be sent via the push server 140, which provides a push notification service. A push notification allows, for example, the application server 150 to communicate with the mobile device 110, even if the mobile device 110 has not explicitly asked for any particular push notification. In order for the application server 150 to send a push notification to the mobile device 110, typically a mobile app 120 on the mobile device 110 provides the application server 150 with appropriate credentials that can be given to the push server 140, so that the push server 140 will know that the mobile device 110 has authorized receiving such push notifications, and so the push server 140 can direct the application server's 150 message to the correct mobile device 110. These credentials may initially be obtained from the push server 140 by the mobile device 110 as part of a mobile app-initiated registration process, which will be explained in further detail below.

Using the push notification to communicate with the mobile app 120 may also allow the application server 150 to update the mobile device 110 regardless of the execution state or context of any particular mobile app 120. For example, if the mobile app 120 to which the push notification is directed is not executing, the operating system 115 may handle it by displaying a notice that, when tapped by the user, launches the mobile app 120 in the same context as before the mobile app 120 was closed, in order to view the content of the push notification in more detail.

The advertising server 145 may store advertisements 125 for display on the mobile device 110 and transmit those advertisements 125 to the mobile device 110 upon request. Additionally or alternatively, the advertising server 145 may interface with a customer relationship management system for managing engagements with users (e.g., potential and/or existing customers). The advertising server 145 may also send and receive messages, to/from the mobile device 110, pertaining to one or more of the displayed advertisements 125. As will be explained in more detail below, the messages sent to the advertising server 145 may be text-based, anonymous, and/or asynchronous to messages received from the advertising server 145, which may also be text-based. The messages sent from the advertising server 145 may be supplied by a customer service representative supporting products and/or services corresponding to the one or more displayed advertisements 125. For example, a customer service representative may access the advertising server 145 via a web interface in order to view messages sent from the mobile device 110, and/or in order to craft an appropriate response thereto.

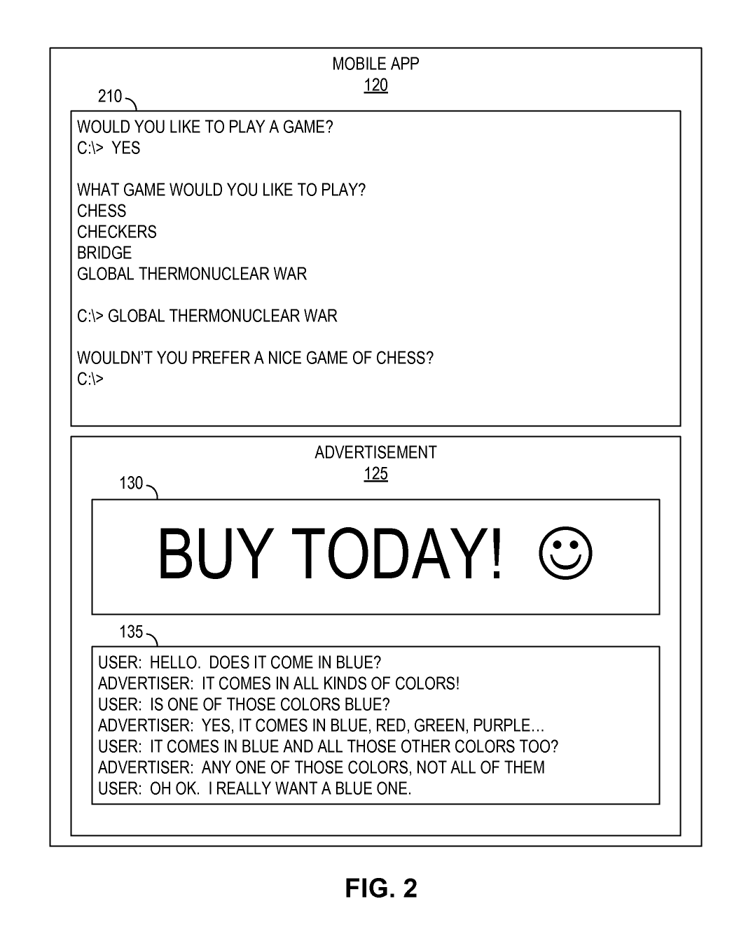

FIG. 2 illustrates an example of a mobile app 120 in a particular context that is displaying a workspace 210 and simultaneously displaying an advertisement 125. The mobile app 120 workspace 210 comprises a simple command line prompt through which the user is entering text in order to interface with the mobile app 120. The mobile app 120 context further comprises an advertisement 125 that is displaying media 130, which according to this particular example is encouraging the user to buy something today. The advertisement 125 is also displaying a messaging area 135 through which messages may be exchanged with a remote customer service representative. According to one or more embodiments, the messaging area 135 may allow these messages to be exchanged with the customer service representative anonymously. In other words, the actual identity of the user and/or mobile device 110 may be withheld from the customer service representative during exchange of messaging via the messaging area 135. Other examples of a mobile app 120 in a particular context may comprise other user interface elements, such as push buttons, pull-down menus, toolbars, and multimedia.

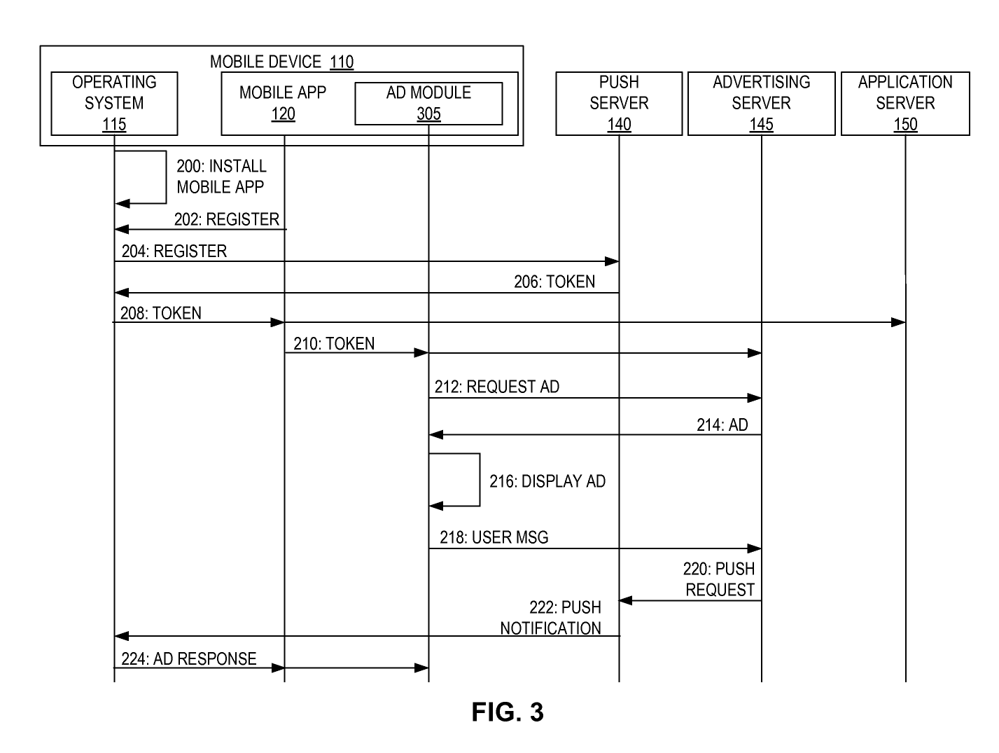

FIG. 3 illustrates an example of how the exchange of messages between the user of the mobile device 110 and the remote customer service representative corresponding to the advertising server 145 may occur. According to the example of FIG. 3, the operating system 115 installs a mobile app 120 that comprises an ad module 305 on the mobile device 110, e.g., at the request of the user (step 200). As part of the installation process, the user of the mobile device 110 may grant the mobile app 120 permission to access the network 105 and/or receive push notifications. The mobile app 120 sends a registration request to the operating system 115, e.g., as part of the installation process, upon first launch of the mobile app 120, or in response to a user configuring the mobile app 120 to register for push notifications (step 202). The operating system 115 sends the registration request to the push server 140 (step 204). In response to the request, the push server 140 generates and returns a device token to the operating system 115 of the mobile device 110 (step 206). The device token may be used as push notification credentials that demonstrate that an associated request for a push notification is authorized by the mobile device 110. Thus, push requests received by the push server 140 that comprise the device token may be sent to the mobile device 110.

Having received the device token, the operating system 115 forwards the device token to the mobile app 120 that initiated the registration, and the mobile app 120 forwards the device token to the application server 150 (step 208). Accordingly, the application server 150 may send push notifications to the mobile app 120 via the push server 140, as needed.

The mobile app 120 also forwards the device token to the ad module 305, and the ad module 305 forwards the device token to the advertising server 145 (step 210). Accordingly, the advertising server 145 may send push notifications to the mobile app 120 via the push server 140, as needed.

The ad module 305 requests an ad from the advertising server 145 (step 212), and the advertising server 145 responds with an ad (step 214). The ad comprises media 130 and a messaging area 135, as described above. The ad module 305 displays the ad within the mobile app 120 (step 216). According to embodiments, the ad module 305 may, alternatively, withhold sending the device token to the advertising server 145 until after identifying that the received ad has a messaging area 135, whereupon the ad module 305 may forward the device token to the advertising server 145 as discussed above.

The ad module 305 then sends a message received from the user to the advertising server 145, for example, to ask a question about something that was in the media 130 of the ad (step 218). For example, the user may provide input to ask what sizes an advertised product comes in, or may ask for pricing information, or whether the advertised product is compatible with the mobile device 110. Having provided this input, the user may continue using the mobile app 120 for other purposes, e.g., by continuing to use a workspace 210 within the mobile app 120, may close the mobile app 120, or may switch to a different mobile app, as desired. In addition, the advertisement 125 may be switched out by the ad module 305.

A customer service representative may be monitoring messages arriving at the advertising server 145, e.g., via a web interface provided to the customer service representative by the advertising server 145. Thus, the customer service representative may craft a response to the user's message, which the advertising server 145 encapsulates in a push request that is sent to the push server 140, along with the device token (step 220). The push server 140 uses the device token in the push request to send a push notification to the mobile device 110, which is initially handled by the operating system 115 on the mobile device 110 (step 222).

The operating system 115 may handle the received push notification in a variety of ways. If the mobile app 120 is still running and actively displayed on the mobile device 110, the operating system 115 may merely forward the advertiser's response to the mobile app 120, which the mobile app 120 subsequently forwards to the ad module 305 for presentation within the messaging area 135 of the advertisement 125 (step 224). If the advertisement 125 has been switched out since the user provided the user input, presentation of the advertiser's response may require the advertisement 125 to be switched back in. If the user has switched to another mobile app since sending the message to the advertising server 145, the operating system 115 may display a visual notification itself that, when tapped by the user, causes the mobile app 120 to be redisplayed to the user so that the advertiser's response may be viewed within the messaging area 135. Similarly, if the user has closed the mobile app 120 since sending the message to the advertising server 145, the operating system 115 may launch the mobile app 120 so that the mobile app 120 may be redisplayed to the user, and so the advertiser's response may be viewed within the messaging area 135. Thus, according to one or more embodiments, the user is free to exchange messages with the customer service representative without impacting their current mobile app 120 context, and further, may close the mobile app 120 or switch to other mobile apps without losing the ability to communicate anonymously and asynchronously with the customer service representative. Further, the advertisement 125 may store the conversation history in a memory of the mobile device 110, so that the conversation history is not lost when the user switches to another mobile app, or closes the mobile app 120 that includes the advertisement 125.

Although the example of FIG. 3 illustrates an example in which the ad module 305 requests the ad from the advertising server 145, according to embodiments, the ad module 305 may request the ad from a separate hosting server (not shown) storing the ad. The hosting server may, thus, respond to the ad module 305 with the ad.

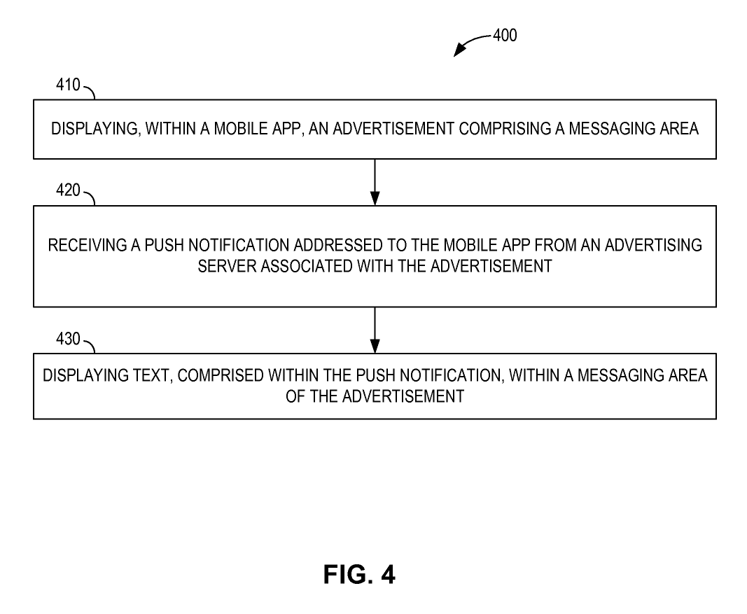

FIG. 4 illustrates an example method 400 of in-ad messaging implemented by a mobile device 110, according to one or more embodiments of the present disclosure. The example method 400 comprises: displaying, within a mobile app 120, an advertisement 125 comprising a messaging area 135 (block 410); receiving a push notification addressed to the mobile app 120 from an advertising server 145 associated with the advertisement 125 (block 420); and displaying text, comprised within the push notification, within a messaging area 135 of the advertisement 125 (block 430).

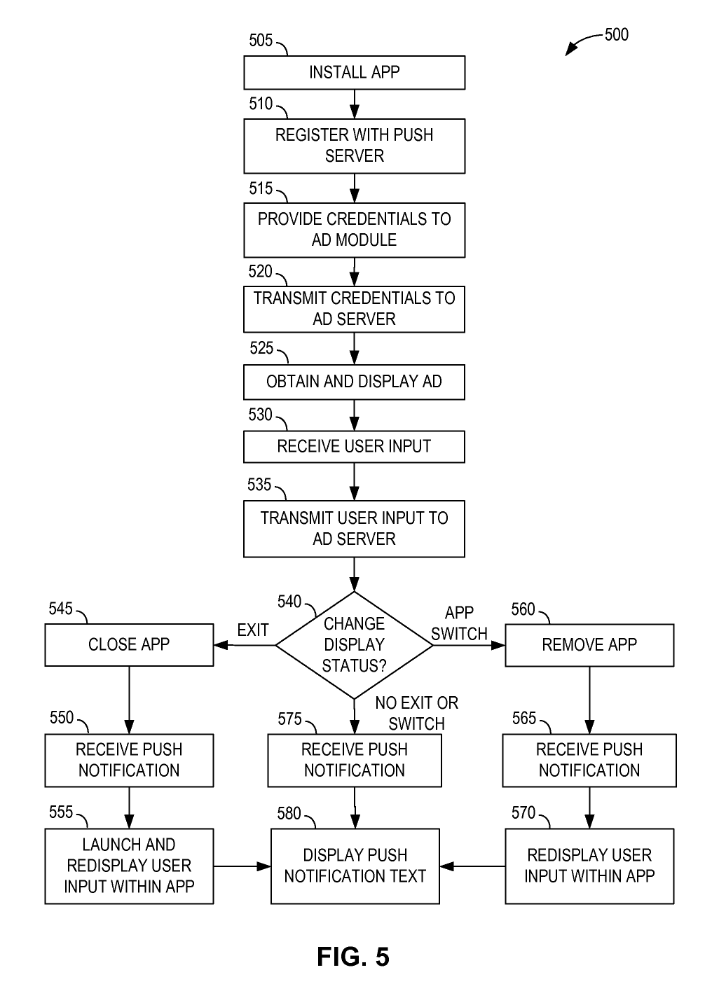

FIG. 5 illustrates an example of a more detailed method 500 of messaging within an advertisement 125 that is implemented by a mobile device 110, according to one or more embodiments of the present disclosure. According to the example illustrated in FIG. 5, the more detailed method 500 begins with the mobile device 110 installing a mobile app 120 (block 505) and registering with a push server 140 (block 510). By registering with the push server 140, the mobile device 110 obtains push notification credentials, which the mobile device 110 provides to an ad module 305 of the mobile app 120 (block 515). The ad module 305 of the mobile app 120 forwards the push notification credentials to an advertising server 145 (block 520). The mobile device 110 then obtains an advertisement 125, (e.g., by sending a request to the advertising server 145 and receiving the advertisement 125 in response) and displays the received advertisement 125 to the user (block 525). The received advertisement 125 comprises a messaging area 135. The mobile device 110 receives user input via this messaging area 135 without causing a change in context to the mobile app 120 (block 530). This user input may be, for example, a question directed to a customer service representative associated with the displayed advertisement 125. The mobile device 110, having received the user input, transmits the user input to the advertising server 145 (block 535).

According to the example method 500 of FIG. 5, the user may (but is not required to) change the display status of the mobile app 120 after transmitting the user input to the ad server (block 540). For example, the user may close the mobile app 120 after transmitting the user input (block 545), such that the mobile device 110 receives a push notification sent from the advertising server 145 via the push server 140 while the mobile app 120 is closed (block 550). In response to receiving the push notification while the mobile app 120 is closed, the mobile device 110 launches the mobile app 120 in order to redisplay the user input within the messaging area 135 of the advertisement 125 within the mobile app 120 (block 555). The mobile device 110 then displays text comprised within the push notification within the messaging area 135 of the advertisement 125 (block 580). The mobile device 110 may then receive further input from the user (block 530) such that the user and customer service representative may exchange messages with each other regardless of whether the mobile app 120 remains open throughout the conversation.

Another example by which the user may change the display status of the mobile app 120 is by switching away from the mobile app 120. For example, the user may minimize the mobile app 120, or may switch to a different mobile app, such that the mobile app 120 is removed from the display of the mobile device 110 (block 560). In response to receiving a push notification sent from the advertising server 145 via the push server 140 while the mobile app 120 is not displayed by the mobile device 110 (block 565), the mobile device 110 redisplays the user input within the messaging area 135 of the advertisement 125 within the mobile app 120 (block 570). The mobile device 110 then displays text comprised within the push notification within the messaging area 135 of the advertisement 125 (block 580). The mobile device 110 may then receive further input from the user (block 530) such that the user and customer service representative may exchange messages with each other regardless of whether the mobile app 120 remains on the display of the mobile device 110 throughout the conversation.

If the user does not change the display status of the mobile app 120 after transmitting the user input to the advertising server 145, in response to receiving a push notification sent from the advertising server 145 via the push server 140 (block 575), the mobile device 110 displays text comprised within the push notification within the messaging area 135 of the already displayed advertisement 125 (block 580). The mobile device 110 may then receive further input from the user (block 530) such that the user and customer service representative may exchange messages with each other as may be desired.

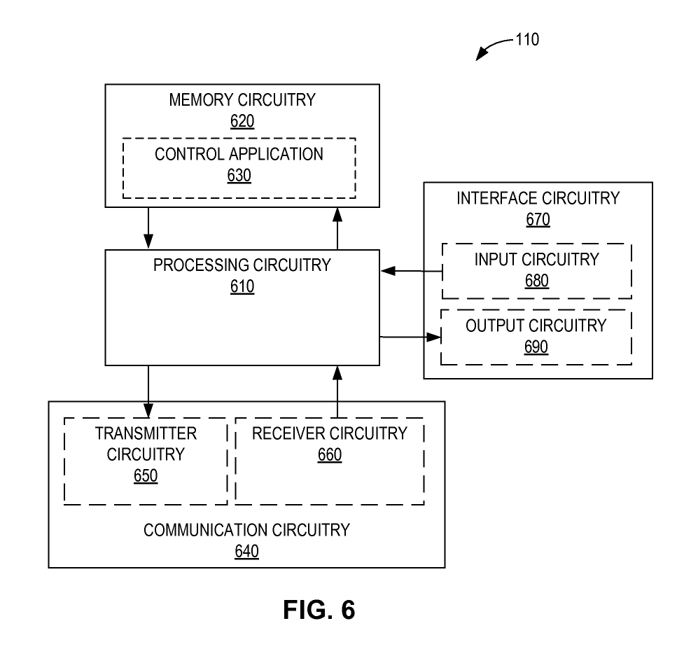

One or more of the mobile device 110, the push server 140, the advertising server 145, and the application server 150 may be implemented according to the example hardware depicted in FIG. 6. The example hardware of FIG. 6 comprises processing circuitry 610, memory circuitry 620, communication circuitry 640, and interface circuitry 670. The processing circuitry 610 is communicatively coupled to the memory circuitry 620, communication circuitry 640, and interface circuitry 670, e.g., via one or more buses. The processing circuitry 610 may comprise one or more microprocessors, microcontrollers, hardware circuits, discrete logic circuits, hardware registers, digital signal processors (DSPs), field-programmable gate arrays (FPGAs), application-specific integrated circuits (ASICs), or a combination thereof. For example, the processing circuitry 610 may be programmable hardware capable of executing machine instructions stored as a machine-readable computer program 630 in the memory circuitry 620. The memory circuitry 620 of the various embodiments may comprise any non-transitory machine-readable media known in the art or that may be developed, including but not limited to solid state media (e.g., SRAM, DRAM, DDRAM, ROM, PROM, EPROM, flash memory, solid state disc, etc.), removable storage devices (e.g., Secure Digital (SD) card, miniSD card, microSD card, memory stick, thumb-drive, USB flash drive, ROM cartridge, Universal Media Disc), or the like.

The communication circuitry 640 may be configured to send and receive wireless communication over a wireless communication network, such as a cellular network. For example, the communication circuitry 640 may be a radio transceiver. According to embodiments, the communication circuitry 640 may comprise distinct transmitter circuitry 650 and receiver circuitry 660. The transmitter circuitry 650 may be configured to send communication signals over the wireless communications network, whereas the receiver circuitry 660 may be configured to receive communication signals over the wireless communications network. Thus, the communication circuitry 640 may be implemented as a unitary physical component, or as a plurality of physical components that may be contiguously or separately arranged, any of which may be communicatively coupled to any other, or may communicate with any other via the processing circuitry 610.

The interface circuitry 670 may be configured to accept input from, and send output to, a user. For example, the interface circuitry 670 may be a touchscreen. According to embodiments, the interface circuitry 670 may comprise distinct input circuitry 680 and output circuitry 690. The output circuitry 690 may be configured to output signals for display to a user. For example, the output circuitry 690 may comprise one or more of a graphics adapter, a graphical processing unit, a display port, a Liquid Crystal display, and a Light Emitting Diode display. The input circuitry 680 may be configured to accept input from a user. For example, the input circuitry 680 may comprise one or more of a pointing device (such as a stylus, touchpad, trackball, or pointing stick), a microphone for speech input, an optical sensor for optical recognition of gestures, and a keypad. Thus, the interface circuitry 670 may be implemented as a unitary physical component, or as a plurality of physical components that may be contiguously or separately arranged, any of which may be communicatively coupled to any other, or may communicate with any other via the processing circuitry 610.

Further, the communication circuitry 640 and interface circuitry 670 may, according to embodiments, be implemented in the same unitary chipset. For example, the communication circuitry 640 may be configured to receive radio signals over the wireless network carrying user input, and may be configured to transmit radio signals over the wireless network carrying output for user feedback and/or display. Alternatively, the communication circuitry 640 and interface circuitry 670 may, according to embodiments, be implemented as a plurality of physical components that may be contiguously or separately arranged, any of which may be communicatively coupled to any other, or may communicate with any other via the processing circuitry 610.

The processing circuitry 610 may be configured to display, within a mobile app 120, an advertisement 125 comprising a messaging area 135 via the interface circuitry 670; receive a push notification addressed to the mobile app 120 from an advertising server 145 associated with the advertisement 125 via the communication circuitry 640; and display text, comprised within the push notification, within the messaging area 135 via the interface circuitry 670. The mobile device 110 may be otherwise configured as described above.

The present invention may, of course, be carried out in other ways than those specifically set forth herein without departing from essential characteristics of the invention. The present embodiments are to be considered in all respects as illustrative and not restrictive.

What is claimed is:

1. A method, implemented by a mobile device, of messaging within an advertisement, the method comprising:
displaying, within a mobile app, an advertisement comprising a messaging area;
receiving a push notification addressed to the mobile app from an advertising server associated with the advertisement; and
displaying text, comprised within the push notification, within a messaging area of the advertisement.

2. The method of claim 1, wherein receiving the push notification is in response to transmitting user input received via the messaging area of the advertisement to the advertising server.

3. The method of claim 2, wherein the user input is received via the messaging area without causing a change in context to the mobile app.

4. The method of claim 2, further comprising:
closing the mobile app subsequent to transmitting the user input; and
in response to receiving the push notification, launching the mobile app in order to redisplay the user input within the messaging area of the advertisement within the mobile app.

5. The method of claim 2, further comprising:
removing the mobile app from display subsequent to transmitting the user input; and
in response to receiving the push notification, redisplaying the user input within the messaging area of the advertisement within the mobile app.

6. The method of claim 2, further comprises:
replacing the advertisement with a different advertisement after transmitting the user input; and
redisplaying the advertisement in response to receiving the push notification.

7. The method of claim 1, further comprising:
registering the mobile app with a push server to obtain push notification credentials;
providing the push notification credentials to an advertising module of the mobile app; and
transmitting the push notification credentials, via the advertising module, to the advertising server.

8. A mobile device comprising:
interface circuitry configured to receive input from, and produce output to, a user;
communication circuitry configured to send and receive radio signals over a wireless network;
processing circuitry communicatively coupled to the interface circuitry and communication circuitry, the processing circuitry configured to:
display, within a mobile app, an advertisement comprising a messaging area via the interface circuitry;
receive a push notification addressed to the mobile app from an advertising server associated with the advertisement via the communication circuitry; and
display text, comprised within the push notification, within the messaging area via the interface circuitry.

9. The mobile device of claim 8, wherein the processing circuitry is configured to receive the push notification in response to transmitting user input received via the messaging area of the advertisement to the advertising server via the communication circuitry.

10. The mobile device of claim 9, wherein the user input is received via the messaging area without causing a change in context to the mobile app.

11. The mobile device of claim 9, wherein the processing circuitry is further configured to:
close the mobile app subsequent to transmitting the user input; and
in response to receiving the push notification, launch the mobile app in order to redisplay the user input within the messaging area of the advertisement within the mobile app via the interface circuitry.

12. The mobile device of claim 9, wherein the processing circuitry is further configured to:
remove the mobile app from display subsequent to transmitting the user input; and
in response to receiving the push notification, redisplay the user input within the messaging area of the advertisement within the mobile app via the interface circuitry.

13. The mobile device of claim 9, wherein the processing circuitry is further configured to:
replace the advertisement with a different advertisement via the interface circuitry after transmitting the user input; and
redisplaying the advertisement via the interface circuitry in response to receiving the push notification.

14. The mobile device of claim 8, wherein the processing circuitry is further configured to:
register the mobile app with a push server to obtain push notification credentials via the communication circuitry;
provide the push notification credentials to an advertising module of the mobile app; and
transmit the push notification credentials, via the advertising module, to the advertising server via the communication circuitry.

15. A non-transitory computer readable medium for controlling a programmable mobile device in a communication network, the computer program product comprising software instructions that, when run on the programmable mobile device, cause the programmable mobile device to:
display, within a mobile app, an advertisement comprising a messaging area;
receive a push notification addressed to the mobile app from an advertising server associated with the advertisement; and
display text, comprised within the push notification, within a messaging area of the advertisement.
